(19) United States
(12) Patent Application Publication
(10) Pub. No.: US 2014/0027007 A1
(43) Pub. Date: Jan. 30, 2014

(54) FLUID CONTROL AND/OR RECYCLING KIT, AND METHODS OF MAKING AND USING THE SAME

(71) Applicant: Juan H. VARGAS, Parlier, CA (US)

(72) Inventor: Juan H. VARGAS, Parlier, CA (US)

(21) Appl. No.: 13/946,974

(22) Filed: Jul. 19, 2013

Related U.S. Application Data
(63) Continuation-in-part of application No. 12/931,780, filed on Feb. 9, 2011, now abandoned.

(51) Int. Cl. F01M 11/04; B65B 5/02; B67C 11/00

(52) U.S. Cl. CPC F01M 11/0458; B67C 11/00; B65B 5/024
USPC 141/1; 206/223; 141/333; 222/189.06; 53/456

(57) ABSTRACT

A method for fluid control including the steps of packaging a fluid product for use by an end user in a packaging container housing substantially everything required for consumption of the fluid product; enclosing in the packaging container a receptacle adapted to be employed to receive degraded fluid prior to use of the fluid product; and substantially sealing the receptacle after receiving the degraded fluid for subsequent transport of the degraded fluid and an apparatus therefor.

### REFERENCE TO RELATED APPLICATIONS

The present application is a continuation-in-part of U.S. patent application Ser. No. 12/931,780, pending, filed on Feb. 9, 2011, incorporated herein by reference.

### FIELD OF THE INVENTION

The present invention relates to a method and apparatus for fluid control and/or to the field of fluid control and/or recycling. More particularly, embodiments of the present invention pertain to an apparatus (e.g., a fluid recycling kit), and to methods for making and using the same, that permit used and replacement fluids of various types to be handled in a manner that is convenient, protective of the environment, and inexpensive.

### BACKGROUND OF THE INVENTION

With the advent of the industrial age and, more recently, the burgeoning of technologies in virtually all areas of endeavor, the use and subsequent need for replacement of operative fluids is of critical importance. This process, unfortunately, is both as tedious and messy as it is critical.

A multiplicity of types of fluids is used in nearly all types of devices. For example, in the case of machinery, the proper and reliable operation thereof is dependent to a significant extent on the fluids that are used therein. In the case of an automotive vehicle, the necessary fluids include lubricating oil, hydraulic fluid, coolant and the like. Lubricating oil is of particularly importance because of the multiplicity of moving parts embodied in an automotive vehicle, the temperatures to which they are subjected, and the velocity at which they must operate. Under such operating conditions, even those that may be characterized as “normal”, the lubricating oil degrades over time and must be replaced for continued operation to be possible. This is of importance so as to avoid inordinate wear, breakdown and other damage.

In the case of automotive vehicles and certainly any other type of machinery having an internal combustion engine, the process by which the oil is drained and replaced is relatively simple. However, the conditions under which it must be performed and requirements associated with these operations can be untidy slow, burdensome and expensive.

The new oil is more expensive than would otherwise be the case because of the cost of the oil itself as well as the packaging and other requirements called for by law. The drained, degraded oil is contaminated with various byproducts of operation such as metal grindings, dirt, grease, other fluids and the like. Consequently, various laws require under penalty of fine, loss of license, or the like that the used oil be disposed of only in accordance with the applicable laws and regulations. Commonly, there are fees required to be paid to the designated operators who are authorized to take possession of the degraded oil.

Because of these considerations and others, individuals frequently change their own oil. However, they usually do not have the proper equipment for this to be performed quickly, cleanly and professionally. For example, the first step is usually to drain the degraded oil from the automotive vehicle. The person usually does not have any reliable means by which the oil can be drained and for receiving the drained oil. Commonly, a drain pan, pot, or other means are used which leads to spillage, creating areas to be cleaned up.

Furthermore, the individual usually has no practical way of disposing of the used oil since, among other things, the oil cannot be securely containerized. The result is that the used oil is frequently simply poured down a storm drain or the like. This, of course, is not only illegal, but also a hazard and an environmental concern.

In addition, those individuals who change their own oil must use a variety of products such as funnels, containers of new oil, cleaning products, towels and the like, adequately to do so. These products are sold separately and frequently through different retail stores. This is inconvenient and time consuming and may, as a consequence, lead to the acquisition of products that are, because of size for example, incompatible for use with each other.

Additionally, packaging of products for these purposes is frequently awkward because of the variables in sizes, number of quarts of oil to be used and the like.

Therefore, it has long been known that it would be desirable to have a method and apparatus for fluid control which permits an individual conveniently to change the oil in an automobile or other piece of machinery; which can readily be sold through stores in a standard size container which can readily be stacked for transport to retail stores, stacked on the shelves for sale, sold and used in a form lending itself for such convenient handling; which provides a means by which waste products produced thereby can be readily disposed of in a legal manner and without damage to the environment; and which is otherwise fully effective in achieving its operational objectives.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

It is an object of the present invention to provide an improved method and apparatus for fluid control.

Another object is to provide such a method and apparatus that facilitate the changing of fluids in a multiplicity of operative environments.

Another object is to provide such a method and apparatus that have application to the control of fluids of all types and particularly those of mechanical devices such as automotive vehicles, machinery and the like.

Another object is to provide such a method and apparatus that have particular utility in changing oil in an automotive vehicle.

Another object is to provide such a method and apparatus that provide for a rapid and clean changing of the oil in a vehicle while affording a convenient means for disposing of, or recycling, the used oil without hazard to the environment.

Another object is to provide such a method and apparatus that are particularly well suited to retail sales of the product, both for consumers and retailers, in that the product is fully containerized while being in the most compact configuration possible.

Another object is to provide such a method and apparatus that operate to insure that the procedure is performed rapidly, arid precisely as required.

Another object is to provide such a method and apparatus that minimize the costs associated with their usage.

Another object is to provide such a method and apparatus that cooperate to provide a procedure that is capable of becoming the standard for a wide variety of industries.

Further objects and advantages are to provide improved elements and arrangements thereof in an apparatus for the purpose described which is dependable, economical, durable and fully effective in accomplishing its intended purposes.

Embodiments of the present invention relate to a fluid dispensing and recycling apparatus, comprising a clean fluid reservoir containing a predetermined amount of clean fluid, a dispenser attached to or in fluid communication with the clean fluid reservoir, a flexible used fluid reservoir configured to receive and contain used fluid, an opening in the flexible used fluid reservoir configured to allow a user to pour the used fluid into the flexible used fluid reservoir or otherwise fill the flexible used fluid reservoir with the used fluid, a cap configured to close or seal the opening in the flexible used fluid reservoir; and a container configured to contain the clean fluid reservoir and the flexible used fluid reservoir. The dispenser is configured to dispense clean fluid from the clean fluid reservoir. The flexible used fluid reservoir has a capacity about equal to the capacity of the clean fluid reservoir. The container has a sidewall aperture through a sidewall thereof, the dispenser extending through the sidewall aperture to a position external to the container. The container also has a top aperture through a top end panel thereof, the opening in the flexible used fluid reservoir and the cap being extendable through the top aperture. The apparatus may further comprise a funnel configured to enable the user to pour the used fluid into the opening in the flexible used fluid reservoir, and optionally, a filter configured to filter or remove solid material from the used fluid larger than a predetermined size. The top of the container may be adhered to flaps extending from sidewalls of the container.

In various embodiments, the clean fluid reservoir comprises a flexible container having a volume about equal to or slightly larger than an amount of clean fluid in the clean fluid reservoir. For example, the clean fluid reservoir may comprise a plastic bag. Also, the fluid comprises an oil or a solvent.

Alternatively or additionally, the dispenser may comprise a spout equipped with a valve configured to open or close the spout, the opening in the flexible used fluid reservoir may comprise a threaded neck, and the cap may comprise a screw cap configured to mate with the threaded neck.

Another aspect of the present invention relates to a method of dispensing and recycling fluid, comprising dispensing clean fluid from a clean fluid reservoir through a spout, collecting used fluid in a flexible used fluid reservoir in a container containing the clean fluid reservoir, and delivering the container with collected used fluid in the flexible used fluid reservoir to an authorized or approved location for recycling of the collected used fluid. The spout generally extends through a first aperture in a sidewall of the container. The flexible used fluid reservoir generally has an opening extending through a second aperture in a top surface or end panel of the container. In some embodiments, the method further comprises filtering the used fluid, before or while the used fluid is collected in the flexible used fluid reservoir, and capping or otherwise sealing the opening in the flexible used fluid reservoir after collecting the used fluid in the flexible used fluid reservoir. In some examples of the method of dispensing and recycling fluid, all of the clean fluid is dispensed and an equal or nearly equal volume of used fluid is collected prior to delivering the container with the collected used fluid to the authorized or approved location.

A further aspect of the present invention generally relates to a method of making a fluid dispensing and recycling apparatus, comprising assembling a partially-closed container from a blank, placing a clean fluid reservoir containing a predetermined amount of clean fluid and a flexible, empty used fluid reservoir configured to receive and contain used fluid in the partially-closed container, and closing a top of the container. The partially-closed container generally has a bottom and a plurality of sidewalls. The clean fluid reservoir has a dispenser attached thereto or in fluid communication therewith. The dispenser is configured to dispense clean fluid from the clean fluid reservoir. The flexible, empty used fluid reservoir generally has (i) an opening configured to allow a user to pour or otherwise fill the flexible used fluid reservoir with the used fluid, (ii) a cap configured to close or seal the opening, and (iii) a capacity about equal to the capacity of the clean fluid reservoir.

In some embodiments of the method of making a fluid dispensing and recycling apparatus, assembling the partially-closed container comprises folding a plurality of bottom flaps and a plurality of top flaps of the blank; folding a sidewall flap and folding the blank along a plurality of sidewall folds to form the plurality of sidewalls; and adhering at least two of the plurality of bottom flaps to form the bottom and adhering a first sidewall to the folded sidewall flap to form the partially-closed container. The method may also further comprise extending the dispenser through a first aperture in one of the plurality of sidewalls to a position external to the container.

In further or additional embodiments, the top of the container may have a perforated area configured to allow the opening and the cap to extend through a top surface or panel of the container after removal of a perforated area in the top surface or panel of the container. The method may further comprise placing a funnel, and optionally, a filter in the partially-closed container, prior to closing the top of the container.

In some embodiments, closing the top of the container comprises gluing a first top flap to the remaining top flap(s), or inserting a top flap extension into the container after folding the plurality of top flaps. In further or alternative embodiments, adhering at least two of the plurality of bottom flaps comprises gluing each of first and second bottom flaps to each of third and fourth bottom flaps, or taping first and second opposed bottom flaps to first and second opposed sidewalls of the container.

These and other objects and advantages are achieved by the present invention in a method for fluid control including packaging a fluid product for use by an end user in a packaging container housing substantially everything required for consumption of the fluid product; enclosing in the packaging container a receptacle adapted to be employed to receive degraded fluid prior to use of the fluid product; and substantially sealing said receptacle after receiving said degraded fluid for subsequent disposal of the degraded fluid, and an and apparatus adapted for the same, as will become readily apparent from the detailed description of various embodiments below.

### BRIEF DESCRIPTION OF THE DRAWINGS

FIG. 1 is an exploded perspective view of an exemplary apparatus of the present invention used in the practice of an exemplary method of the present invention.

FIG. 2 is a somewhat enlarged perspective view of the exemplary apparatus of FIG. 1 as it appears in its sealed, containerized configuration.

FIG. 3 is a perspective view of the receptacle of the exemplary apparatus of FIG. 1 employed in the present invention and deployed in a folded configuration to be sealed in the container or as taken from the container.

FIG. 4 is a perspective view of a funnel employed in the exemplary apparatus of FIG. 1.

FIG. 5 is a top plan view of a first container blank employed in forming a container for the exemplary apparatus of FIG. 1 that is shown in assembled form in FIG. 2.

FIG. 6A is a diagram showing a second exemplary container blank in accordance with another aspect of the present invention.

FIG. 6B is a diagram showing several views of an exemplary apparatus including a container made from the exemplary blank of FIG. 6A and optional equipment for use with the apparatus in accordance with the present invention.

FIG. 6C is a diagram showing an exemplary used fluid reservoir in accordance with the exemplary apparatus of FIG. 6B.

FIG. 7 is a flow chart for an exemplary method of manufacturing a fluid dispensing and recycling apparatus in accordance with another aspect of the present invention.

FIG. 8 is a diagram showing a third exemplary container blank in accordance with the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention as defined by the appended claims. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention. Also, various aspects, embodiments and/or examples disclosed herein may be combined with other aspects, embodiments and/or examples, as long as such combinations are not explicitly disclosed herein as being unfavorable, undesirable or disadvantageous.

For the sake of convenience and simplicity, the terms “connected to,” “coupled with,” “communicating with,” and “coupled to” (which terms also refer to direct and/or indirect relationships between the connected, coupled and/or communicating elements unless the context of the term's use unambiguously indicates otherwise). Such terms may be used interchangeably, but these terms are also generally given their art-recognized meanings

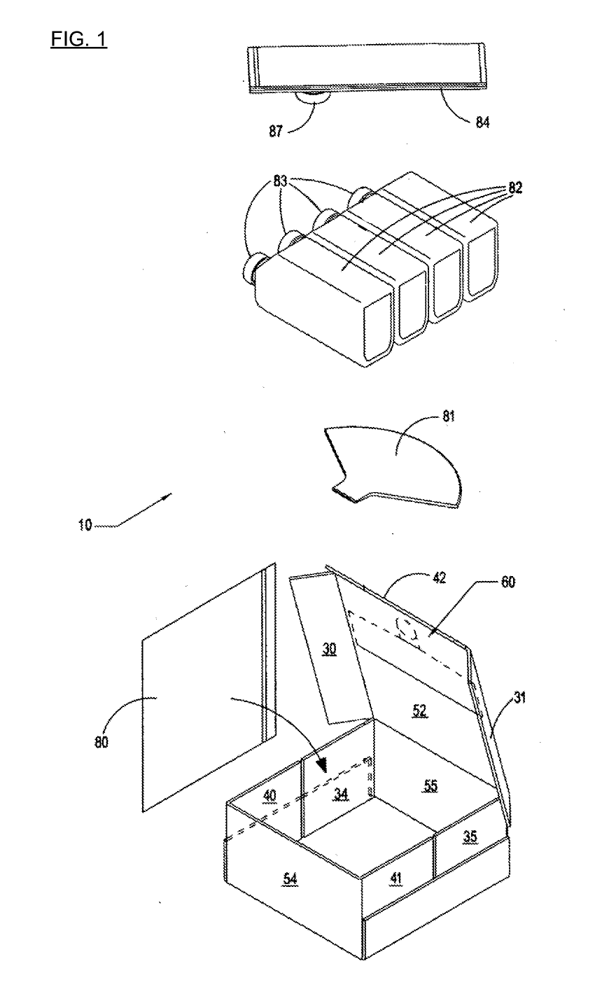

Referring more particularly to the drawings, the apparatus of the present invention in generally indicated by the numeral 10 in FIG. 1.

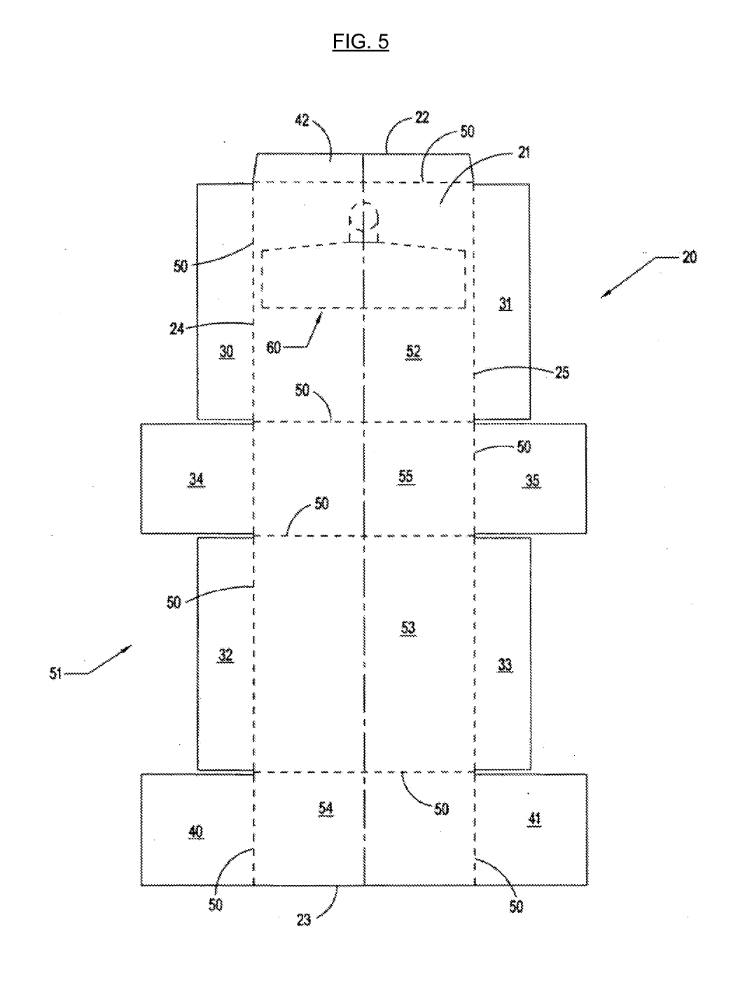

The apparatus is formed, in part, from a container blank 20, shown in FIG. 5, which has a rectangular central panel 21. The central panel has an upper edge 22 and a parallel lower edge 23. The designations “upper” and “lower”, a used herein are solely in reference to the relative positions of these elements in FIG. 5. It will also be understood that the container blank 20 is formed from a single piece of a suitable material such as cardboard. The central panel has a left edge 24 and an opposite substantially parallel right edge 25. A left upper flap 30 is mounted on and extends outwardly form the left edge 24. A right upper flap 31 is mounted on and extends outwardly form the right edge 25. Similarly, a left lower flap 32 is mounted on and extends outwardly the left edge of the central panel 21. A right lower flap 33 is mounted on and extends outwardly form the right edge 25.

A left central flap 34 is mounted on and extends outwardly form the left edge 24. A right central flap 35 is mounted on and extends outwardly form the right edge 25. A left lower flap 40 is mounted on and extends outwardly form the left edge 24. A right lower flap 41 is mounted on and extends outwardly form the right edge 25. An upper flap 42 is mounted on and extends upwardly form the upper edge 22 of the central panel.

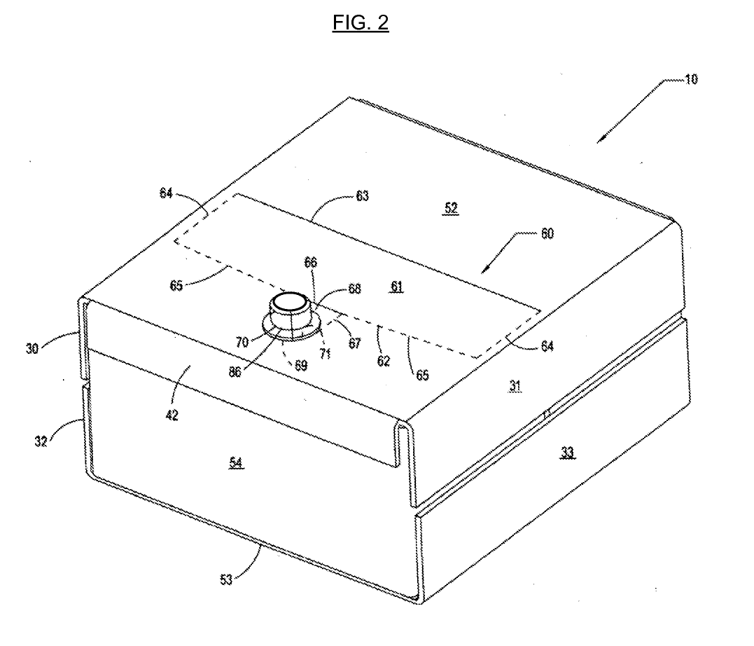

The container blank 20 has fold lines 50 about which portions of the container blank are folded, as will hereinafter be described in greater detail, in forming the apparatus for fluid control of the present invention 10 shown in FIG. 2. The fold lines 50 are shown and so identified in FIG. 5. The container blank 20 is folded by any suitable means to form a container 51 of the present invention 10. The formed container is shown in FIGS. 1 and 2. The container 51 is shown prior to formation in FIG. 5 as the container blank 20. For purposes of identification of the portions of the container, it will be understood that the container has, as identified in FIG. 5, a first sidewall 52, a second sidewall 53, a first endwall 54 and a second endwall 55.

The container blank 51 is folded along the fold lines 50 so that the first sidewall 52 is disposed in substantially parallel relation to the second sidewall 53. Similarly, the first endwall 54 and second endwall 55 are disposed in substantially parallel relation to each other. The left central flap 34 and the right central flap 35 are folded into parallel relation to each other. The left lower flap 40 and the right lower flap 41 are folded into parallel relation. The left upper flap 30, right upper flap 31, left lower flap 32 and right lower flap 33 are folded into facing engagement with the aforementioned flaps to form the container 51, as shown in FIG. 2. Hot melt glue is preferably employed to form a secure seal in the areas of overlap. It will be understood that the complete construction of the container heretofore set forth is not completed until the other portions of the invention are placed within the container, as will hereinafter be set forth. The foregoing description of the formation of the container is simply for illustrative convenience.

As shown in FIGS. 1, 2 and 5, the first sidewall 52 of the container has an access door or flap assembly generally indicated by the numeral 60. The access door or flap assembly has an access door or flap 61 that fills an access opening 62. It will be understood that the access door or flap assembly 60 is formed in and constructed entirely of the material from which the first sidewall 52 is constructed, as shown best in FIG. 2. The access flap is bounded by a fold line 63, opposite perforated end lines 64 and a pair of spaced perforated front lines 65. The perforated front lines are interconnected by a tab fold line 66. A pair of parallel perforated tab lines 67 extend from the tab fold line to bound a tab 68. The tab 68 communicates with a circular perforated line 69 that bounds a removable circular plug 70. The plug, when removed along the circular perforated line, leaves a circular drain opening 71 for purposes hereinafter described.

Referring more particularly to FIG. 1˜the exploded view thereof illustrates the contents of the container 51. The contents include, as first placed in the container 51 a sealable container 80 such as a “ZIP LOCK” bag of a size adequate to house a used oil filter, not shown. The sealable container is laid flat on the right central flap 35 and right lower flap 41 adjacent to the access flap assembly 60. A collapsed, or flattened biodegradable funnel 81 is rested on the sealable container 80 within the container 51 again adjacent to access flap assembly 60. Rested on and above the biodegradable funnel are four (4) quart containers of oil 82, in this case fresh motor oil. The quart containers are substantially identical being of the same size and shape. Each of the quart containers has a removable and resealable cap 83. The container 51 has an interior size and configuration adapted to be received in the interior of the container in fitted relation therewithin. It will be understood that the apparatus 10 is intended to be of a size operable to receive quart containers of oil in the exact number required by the engine involved in fitted relation therein. Thus, the container may be of a size to receive, for example, four (4) or five (5) such quart containers.

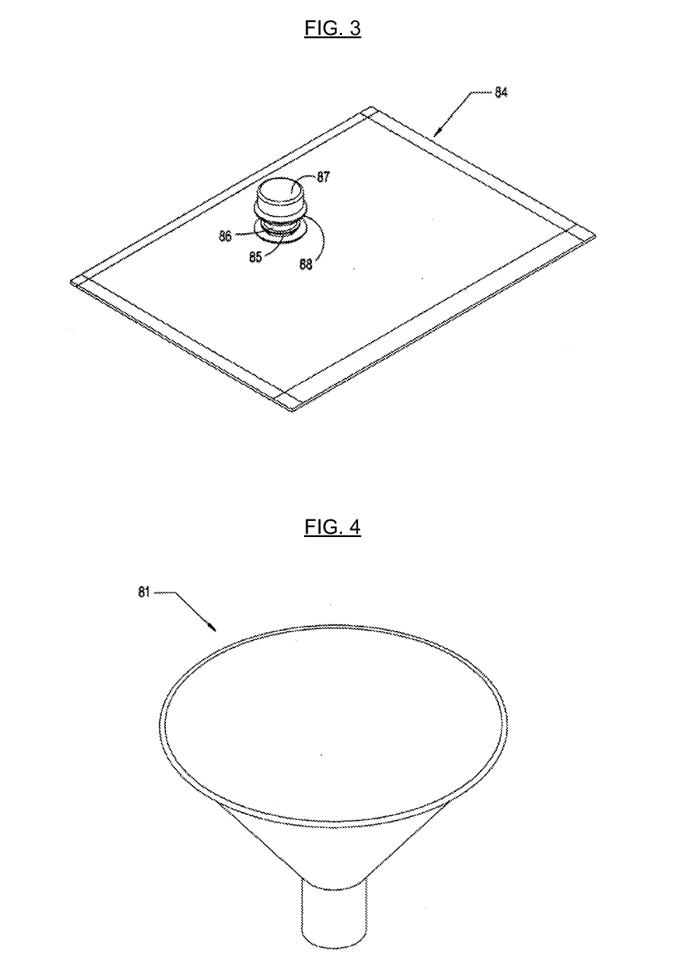

A used oil container assembly 84, which is folded into a flattened configuration as shown in FIG. 3, is positioned within the container 51 preferably inverted and rested upon the shoulders of the quart containers, as can best be visualized upon reference to FIG. 1. The container assembly 84 has a throat member 85 that is mounted thereon in fluid sealing relation in communication with the interior of the container assembly. More specifically, the throat member has a throat, not visible, extended therethrough from the exterior to the interior of the container assembly. The throat member is encircled with screw threads 86. A cap 87 is screw-threadably, and thus removably, attached to the screw threads of the throat member. The cap has a downwardly and laterally extending skirt 88 extending thereabout for purposes hereinafter set forth. Accordingly, removal of the cap opens the container assembly for the receipt of used motor oil in the interior of the container assembly.

The volume of the interior of the used oil container assembly 84 is sufficient to hold at least about the volume of the oil drained from the vehicle. This is, of course, the total volume of fresh oil contained in the four (4) quart containers of motor oil 82.

Exemplary Operation(s)

The operation of the described embodiment of the subject invention is believed to be clearly apparent and is briefly summarized at this point.

As previously noted, the method and apparatus 10 for fluid control of the present invention can be employed for virtually any fluid, such as for example, motor oil, hydraulic fluid, coolant and the like. For illustrative convenience, the use of the method and apparatus hereof will be described with respect to motor oil.

It will become more readily apparent that the apparatus 10 contains everything necessary to perform the operation of changing or replacing the motor oil in an internal combustion engine or the like. The apparatus contains means for easily removing the used engine oil, provides the means by which it can be recycled or disposed of without any spillage, provides the funnel for pouring into the engine the new or fresh motor oil, provides a means by which the old oil filter of the engine can be disposed of without damage to the environment and similarly permits the biodegradable funnel to be disposed of without damage to the environment.

The foregoing method is performed by first removing everything from the interior of the container 51 except the used oil container assembly. Removal of the contents is accomplished by pulling up on the tab 68 and tearing the perforated tab lines 67 to free the tab. The access flap 61 is similarly tom along the perforated front lines 65 and perforated end lines 64 to free the access flap 61. The items in the interior of the container 51 are then simply pulled therefrom or dropped out through the access opening 62.

Used oil container assembly 84 can be removed from the interior, unfolded and pulled open or blown into to open it up. It is then placed back in the interior of the container 51. The plug 70 is removed to form the drain opening 71. The cap 87 is removed from the throat member and the throat member is forced into and upwardly through the drain opening 71 to hold it in a ready position.

The funnel 81 is opened from its flattened condition and placed in receiving relation in the throat member 85. The container, so arranged, is then placed beneath the drain plug of the engine, the plug removed and the used oil permitted gravitationally to flow through the funnel, the throat member and into the used oil container assembly. When sufficient time has elapsed to have allowed all of the used oil to fill the used oil container assembly, the cap 87 is again screw-threadably received on the screw threads of the throat member. The tab is inserted beneath the skirt 88 and the cap tightened down to hold the tab in a closed position together with the access flap 61. The container 51 with the used oil sealed inside can thereafter be shipped for recycling or disposal.

After reinsertion and tightening of the drain plug of the engine, the fresh engine oil is then poured into the engine using the funnel 81, if desired. If the oil filter has been replaced, the old oil filter can be disposed of, or recycled contained in the sealable container 80.

A Second Exemplary Container and Apparatus

The present invention further relates to a fluid dispensing and recycling apparatus, which may comprise a container and kit. The container may be a box or other substantially closed or closeable structure having four sidewalls, a top and a bottom. The kit may comprise the container, a clean fluid reservoir, and a flexible used fluid reservoir. In certain embodiments, the kit may further comprise a funnel, and optionally, a filter.

The clean fluid reservoir is configured to contain a predetermined amount of clean fluid. While the predetermined amount of clean fluid can be any amount possible or consistent with the present disclosure, in various embodiments, the predetermined amount of clean fluid can be from 1 liter or 1 quart to 20 liters or 5 gallons, or any value or range of values therein. The clean fluid reservoir may comprise a first leak-proof bag or other sealably closeable vessel for containing fluid. The bag may comprise a sealed plastic bag having a wall thickness sufficient to resist punctures and impact damage (e.g., 3-10 mils thick), and be made of a material that does not dissolve to any appreciable extent in the clean fluid (e.g., polyethylene, polypropylene, etc.). The clean fluid reservoir may alternatively comprise a relatively stiff plastic that substantially retains its shape whether filled with clean fluid or when empty, but preferably the clean fluid reservoir is made of a flexible material that decreases in volume as fluid is dispensed therefrom, thereby enabling the user to fill the used fluid reservoir with an approximately equal amount of used fluid as the clean fluid is dispensed or withdrawn. Suitable materials for the clean fluid vessel may include polyethylene, polypropylene, polyurethanes, polycarbonates, blends and copolymers thereof, etc.

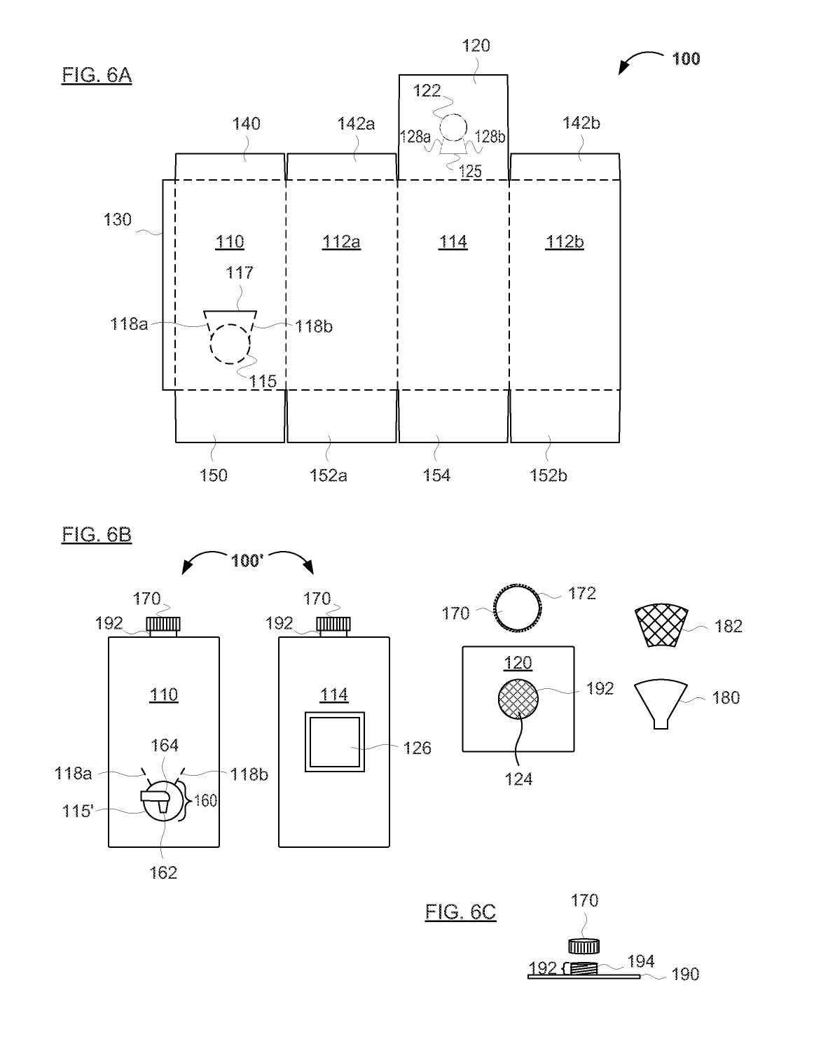

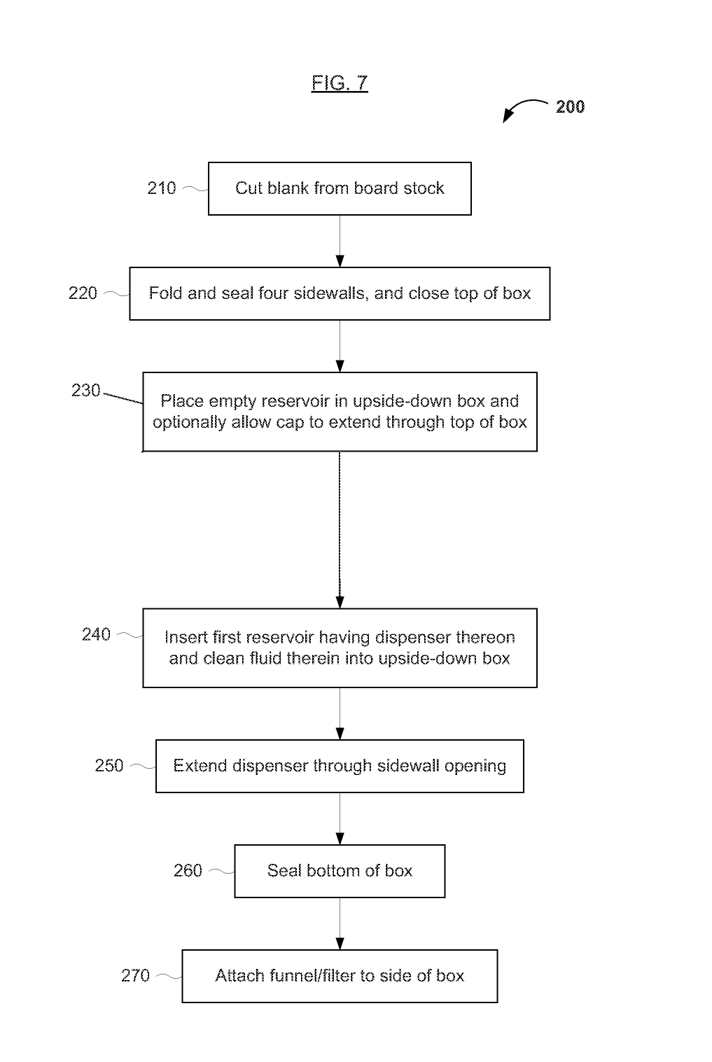

The clean fluid reservoir also includes a dispenser attached to the reservoir or in fluid communication with the clean fluid. The dispenser is configured to dispense clean fluid from the clean fluid reservoir (see FIG. 6B). The clean fluid reservoir may have a sealable opening and a cap, plug or other sealing mechanism (for example, to permit the clean fluid manufacturer, distributor, wholesaler or retailer to put the clean fluid therein), but this opening is not required if the clean fluid is placed in the reservoir through the same opening that the dispenser is placed in.

The flexible used fluid reservoir is configured to receive and contain used fluid, and generally has a capacity about equal to the capacity of the clean fluid reservoir, although in some applications (e.g., cooking oil, paint thinner, etc.), a capacity slightly less (e.g., 10-20% less) than the clean fluid reservoir may be suitable. The flexible used fluid reservoir also has an opening configured to allow a user to pour the used fluid into the flexible used fluid reservoir or otherwise fill the flexible used fluid reservoir with the used fluid, and a cap configured to close or seal the opening.

The box or other container may be configured to contain the clean fluid reservoir and the used fluid reservoir. The box has a sidewall aperture through a first sidewall, to enable a dispenser on the clean fluid reservoir to extend through the aperture to a position external to the box. The box also has a top aperture through the top of the box, such that at least part of an opening in the flexible used fluid reservoir and a cap being extendable through the top aperture.

FIG. 6A shows a container blank 100 for a box suitable for the present fluid dispensing and recycling apparatus. The blank 100 may be a preformed, scored and/or partially perforated material for the container in which the clean and used fluid reservoirs are placed. The material for the blank 100 may comprise corrugated or uncorrugated paper, paperboard, cardboard, laminates thereof (e.g., paperboard or corrugated paper laminated with plastic and/or foil), combinations thereof, etc.

Blank 100 has four sidewalls 110, 112a-b, and 114; a top flap 120; a sidewall sealing flap 130; three top sealing flaps 140 and 142a-b; and four bottom flaps 150, 152a-b, and 154. The dashed lines between each of the sidewalls 110, 112a-b, and 114, between first sidewall 110 and sidewall sealing flap 130, between third sidewall 114 and top flap 120 on the one end and bottom flap 154 on the other end, and between each of the sidewalls 110 and 112a-b and top sealing flaps 140 and 142a-b on the one end and bottom flaps 150 and 152a-b on the other end represent scores, or folding lines in the blank 100.

The first sidewall 110 includes a circular perforation 115 defining an opening through which a dispenser for the clean fluid reservoir extends. Perforation 115 may have any other shape configured to form an opening in sidewall 110 through which the dispenser can extend, such as oval, square, rectangular, irregular, etc. Perforated lines 118a-b extending away from perforation 115 toward endpoints of folding line 117 provide additional area through which the dispenser can be placed through the opening in the sidewall 110, and which can be resealed when the dispenser has a base with a slightly larger area than that of the opening defined by perforation 115.

Top flap 120 includes a circular perforation 122 defining an opening through which an opening and a cap for the used fluid reservoir extends. Perforation 122 may have any other shape configured to form an opening in sidewall 110 through which the used fluid reservoir opening and cap can extend, such as oval, square, rectangular, irregular, etc., but it is generally circular. Perforated lines 128a-b extending away from perforation 122 toward endpoints of folding line 127 provide additional area so that the slightly larger used fluid reservoir opening and cap can be pushed through the top flap 120, then resealed when the additional area defined by perforation lines 128a-b and folding line 127 is pushed back into place afterwards.

FIG. 6B shows various views of the assembled apparatus 100′ and components therein. For example, sidewall 110 with an opening 115′ therein (formed by removing the perforated circular region 115 in FIG. 6A) has a clean fluid dispenser 160 extending through the opening 115′. Dispenser 160 includes a handle 164 that opens and closes a valve (not shown) based on the position of the handle 164. As can be seen in FIG. 6B, the additional area defined by perforated lines 118a-b and folding line 117 can be effectively closed when the dispenser 160 has a base extending through the opening 115′ in sidewall 110 with a slightly larger area than that of the opening 115′. A cap 170 sealably attached to the opening 192 to the used fluid reservoir (not shown in FIG. 6B) is shown extending from the top of the assembled apparatus 100′. (Once assembled, the top and bottom end flaps may be considered to be top and bottom end panels of the assembled box.)

Third sidewall 114 has a sleeve or envelope 126 adhered to it. The sleeve or envelope 126 may comprise a thin, flexible material such as paper and/or plastic. The sleeve or envelope 126 may have dimensions configured to hold a flat, expandable funnel 180 and, optionally, a flat, expandable filter 182 (e.g., when the used fluid reservoir does not include built-in filter 124). The sleeve or envelope 126 may alternatively or additionally contain a sheet of written instructions, product information relating to the clean fluid, tape strips to reseal the perforated lines extending away from the openings in the sidewall and/or top, etc.

Top end wall 120 of the assembled apparatus 100′ is shown with opening 192 of the used fluid reservoir extending through the opening in the top end wall 120 formed by removing the perforated circular region 122 in FIG. 6A. A filter 124 immediately below the opening 192 (e.g., on the inner surface of the used fluid reservoir) is exposed through the opening 192. The filter 124 is configured to remove solid particles above a certain size from the used fluid to facilitate recycling of the used fluid. The filter 124 may comprise a plastic, paper, fiber, metal of other mesh or screen. Also, the filter 124 may have a depressed, concave, or hemispherical shape. Cap 170 is configured to seal the opening 192, and has a plurality of ribs or projections 172 thereon to facilitate grasping, twisting or turning the cap 170.

FIG. 6C shows flat, flexible used fluid reservoir 190 with opening 192 extending therefrom and cap 170 configured to seal opening 192. For example, the opening may have one or more screw threads 194 thereon, and cap 170 may have one or more complementary threads on the inner sidewall surface thereof. Alternatively, cap 170 and opening 192 may mate using one or more interlocking rings (e.g., a “snap-cap” configuration), inner and outer cylinders on cap 170 spaced apart by a distance that causes a compressive force on opening 192, etc.

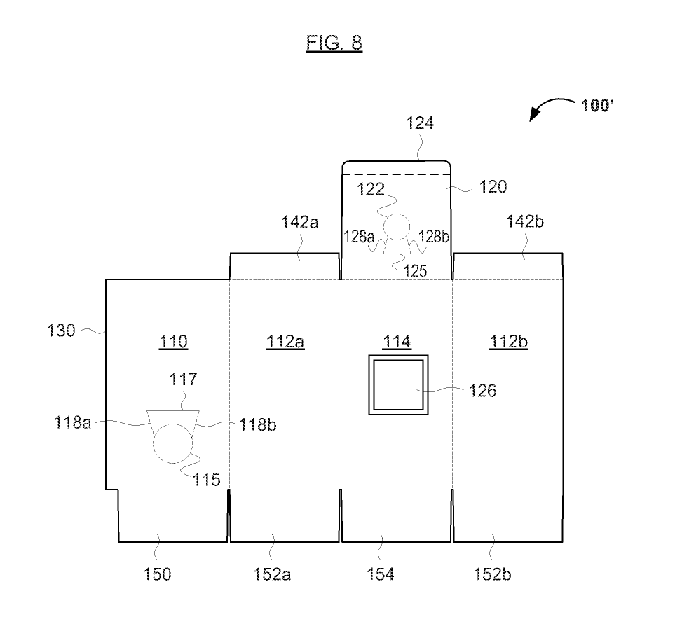

FIG. 7 is a flow chart 200 showing exemplary steps of an exemplary method for assembling the apparatus (e.g., apparatus 100′ of FIG. 6B). At step 210, a blank (e.g., apparatus blank 100 of FIG. 6A) is cut from stock material (e.g., board stock, such as paperboard, cardboard, laminated board stock, etc.). Fold lines may be scored thereon, and perforations formed therein in accordance with conventional box manufacturing techniques.

At 220, the four sidewalls of the blank are folded, and the top flap and top sealing flaps of the blank are folded toward each other, simultaneously and/or sequentially (if sequentially, in any possible order, sequence and/or combination). The fourth sidewall (e.g., sidewall 112b in FIG. 6A) is sealed to a sidewall flap (e.g., sidewall flap 130 in FIG. 6A), generally by adhering or gluing (e.g., using a hot melt adhesive). Top sealing flaps 142a-b and top sealing flap 140 may be folded inwardly before top flap 120. Top flap 120 may be adhered to top sealing flaps 140 and 142a-b (e.g., by gluing using a hot melt adhesive) or by taping (e.g., using a relatively wide packing tape or glue-backed paper tape) to form the top end panel and close the top of the box. In an alternative approach (e.g., as shown in part in FIG. 8), the top flap may have a foldably attached flap extension (e.g., 124) that can be inserted into the box between the front sidewall 110 and the top sealing flaps 142a-b, thereby avoiding a need to adhere or glue the top flap 120 to the top sealing flaps.

At 230, the empty reservoir (e.g., the used fluid reservoir) is placed or inserted into the partially closed/sealed box. To facilitate the manufacturing flow, the components of the kit may be placed into the box while the box is upside-down. Preferably, the cap and opening of the empty reservoir are positioned over or in alignment with the perforated region in the top end panel of the box. Also, the empty used fluid reservoir may be placed as flat as possible along the top flap and one or more sidewalls of the box.

At 240, a bag having a dispenser or spout thereon and clean fluid therein (e.g., the clean fluid reservoir) may be placed on top of the used fluid reservoir in the box, preferably such that the dispenser and spout are substantially aligned with the perforated region in the sidewall of the box. The full clean fluid reservoir may be placed on the empty used fluid reservoir in any particular manner or arrangement enabling the empty used fluid reservoir to be filled as the clean fluid reservoir is emptied. It is also not required that the empty used fluid reservoir be placed flat in the box along the top flap and one or more sidewalls, or that the opening and cap be placed under the center of the end panel of the box, but such an arrangement lends itself to facile assembly and use of the box, with minimal spilling of used fluid and optimized mechanical properties of the box and the reservoirs. For example, such an arrangement may enable the used fluid reservoir to remain on top of the clean fluid reservoir when in use, thereby putting additional pressure on the clean fluid reservoir and aiding more complete removal or dispensing of clean fluid (e.g., more clean fluid can be dispensed from the clean fluid reservoir in the presence of a full or substantially full used fluid reservoir than in the absence of the used fluid reservoir). Then, at 250, the dispenser or spout is extended through the sidewall opening of the box. In some embodiments, the sidewall of the box is “reconstructed” under the base of the dispenser, and perforated lines extending away from the opening through which the dispenser is placed may be sealed (e.g., with tape or other adhesive).

At 260, two of the bottom flaps (e.g., bottom flaps 150 and 154, or bottom flaps 152a-b) are folded inwardly, and the other two bottom flaps folded thereover or sealed thereto to form the bottom end panel and complete the assembly of the box. For example, the overlying bottom flaps may be sealed to the underlying bottom flaps using a hot melt adhesive or double-sided tape. Alternatively, the overlying bottom flaps may be taped to each other (and optionally to two opposed sidewalls of the box) using conventional box or container sealing tape.

Once the box is sealed or closed, the top end panel can be pushed onto the cap and opening of the used fluid reservoir to extend the cap and opening of the used fluid reservoir through the top end panel. Alternatively, an opening can be formed in the top flap prior to sealing the top flap, so that the cap and opening of the used fluid reservoir extend through the opening formed in the top flap without exerting pressure on the top end panel.

Optionally, at 270, an envelope or sleeve can be attached to a side panel of the box (e.g., by gluing or taping), and a flat but expandable funnel and/or filter can be placed in the envelope or sleeve. These steps can also be performed in the reverse sequence. The funnel and/or filter may be made of paper, a thin but somewhat stiff plastic, a combination or laminate thereof, etc. Thus, in an alternative embodiment, the flat but expandable funnel and/or filter can be simply adhered to the side of the box using a small amount of removable adhesive (e.g., a gum, removable or low-residue glue, tack or putty) or double-sided tape. Also, written instructions, product information (e.g., relating to the clean fluid), tape strips to reseal the box, etc., may be included in the envelope or sleeve. Thus, the envelope or sleeve may have dimensions of from 2 inches to 6 inches long, 2 inches to 5 inches wide, and V8 to 1 inch thick.

FIG. 8 shows an alternative blank 100″ for the present box/apparatus. Blank 100″ is substantially identical to blank 100 of FIG. 6A, except that top sealing flap 140 is not present, and top flap 120 has a foldable top flap extension 125. The foldable top flap extension 125 generally folds inwardly toward the partially-closed box, and is inserted into the partially-assembled box behind the first sidewall 110. When the top sealing flap 140 is not present, there is generally sufficient room between the first sidewall 110 and the top sealing flaps 142a-b to insert the top flap extension 125. The top sealing flaps 142a-b may have dimensions that result in a compressive force being applied to the top flap extension 125 when the top flap extension 125 is inserted between the first sidewall 110 and the top sealing flaps 142a-b. In this embodiment, there is no need for a sleeve or envelope on the side of the container, as additional components (such as a funnel, filter, instructions, product literature, etc.) may be placed in or on the partially-closed container prior to closing the container, and removed prior to use of the container to collect used fluid.

### CONCLUSION/SUMMARY

Therefore, the method and apparatus for fluid control of the present invention permit an individual conveniently to change the oil in an automobile or other piece of machinery; can readily be sold through stores in standard size containers which can readily be stacked for transport to retail stores, stacked on the shelves for sale, sold and used in a form lending itself to convenient handling; provide a means by which waste products produced thereby can readily be recycled or disposed of in a legal manner and without damage to the environment; and are otherwise fully effective in accompanying its operational objectives.

Although the invention has been herein shown and described in what is conceived to be the most practical and preferred embodiment, it is recognized that departures may be made therefrom within the scope of the invention which is not to be limited to the illustrative details disclosed. The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A fluid dispensing and recycling apparatus, comprising:
a) a clean fluid reservoir containing a predetermined amount of clean fluid;
b) a dispenser attached to or in fluid communication with the clean fluid reservoir, the dispenser configured to dispense clean fluid from the clean fluid reservoir;
c) a flexible used fluid reservoir configured to receive and contain used fluid, the flexible used fluid reservoir having a capacity about equal to the capacity of the clean fluid reservoir;
d) an opening in the flexible used fluid reservoir configured to allow a user to pour the used fluid into the flexible used fluid reservoir or otherwise fill the flexible used fluid reservoir with the used fluid;
e) a cap configured to close or seal the opening in the flexible used fluid reservoir; and
f) a container configured to contain the clean fluid reservoir and the flexible used fluid reservoir, the container having a sidewall aperture through a sidewall thereof, the dispenser extending through the sidewall aperture to a position external to the container, and the container having a top aperture through a top thereof, the opening in the flexible used fluid reservoir and the cap being extendable through the top aperture.

2. The apparatus of claim 1, further comprising a funnel configured to enable the user to pour the used fluid into the opening in the flexible used fluid reservoir.

3. The apparatus of claim 2, further comprising a filter configured to filter or remove solid material from the used fluid larger than a predetermined size.

4. The apparatus of claim 1, wherein said clean fluid reservoir comprises a flexible container having a volume about equal to or slightly larger than an amount of clean fluid in the clean fluid reservoir.

5. The apparatus of claim 4, wherein the clean fluid reservoir comprises a plastic bag.

6. The apparatus of claim 1, wherein the dispenser comprises a spout equipped with a valve configured to open or close the spout.

7. The apparatus of claim 1, wherein the opening in the flexible used fluid reservoir comprises a threaded neck, and the cap comprises a screw cap configured to mate with the threaded neck.

8. The apparatus of claim 1, wherein the top of the container is adhered to flaps extending from sidewalls of the container.

9. The apparatus of claim 1, wherein the fluid comprises an oil or a solvent.

10. A method of dispensing and recycling fluid, comprising:
a) dispensing clean fluid from a clean fluid reservoir through a spout, the clean fluid reservoir being contained within a container, and the spout extending through a first aperture in a sidewall of the container;
b) collecting used fluid in a flexible used fluid reservoir in the container, the flexible used fluid reservoir having an opening extending through a second aperture in a top surface of the container; and
c) delivering the container with collected used fluid in the flexible used fluid reservoir to an authorized or approved location for recycling of the collected used fluid.

11. The method of claim 10, further comprising, before or during collecting the used fluid in the flexible used fluid reservoir, filtering the used fluid.

12. The method of claim 10, further comprising, after collecting used fluid in the flexible used fluid reservoir, capping or otherwise sealing the opening in the flexible used fluid reservoir.

13. The method of claim 10, wherein all of the clean fluid is dispensed and an equal or nearly equal volume of used fluid is collected prior to delivering the container with the collected used fluid to the authorized or approved location.

14. A method of making a fluid dispensing and recycling apparatus, comprising:
a) assembling a partially-closed container from a blank, the partially-closed container having a bottom and a plurality of sidewalls;
b) placing a clean fluid reservoir containing a predetermined amount of clean fluid and a flexible, empty used fluid reservoir configured to receive and contain used fluid in the partially-closed container, the clean fluid reservoir having a dispenser attached thereto or in fluid communication therewith, the dispenser configured to dispense clean fluid from the clean fluid reservoir, and the flexible, empty used fluid reservoir having (i) an opening configured to allow a user to pour or otherwise fill the flexible used fluid reservoir with the used fluid, (ii) a cap configured to close or seal the opening, and (iii) a capacity about equal to the capacity of the clean fluid reservoir; and
c) closing the container.

15. The method of claim 14, wherein assembling the partially-closed container comprises:
a-1) folding a plurality of bottom flaps and a plurality of top flaps of the blank;
a-2) folding a sidewall flap and folding the blank along a plurality of sidewall folds to form the plurality of sidewalls;
a-3) adhering a first sidewall to the folded sidewall flap; and
a-4) closing a top flap, or adhering the top flap to one or more remaining top flaps, to form a first end panel of the container.

16. The method of claim 14, further comprising extending the dispenser through a first aperture in one of the plurality of sidewalls to a position external to the container.

17. The method of claim 14, wherein the top of the container has a perforated area configured to allow the opening and the cap to extend through a top surface of the container after removal of the perforated area.

18. The method of claim 14, further comprising placing a funnel, and optionally, a filter in or on the partially-closed container, prior to closing the top of the container.

19. The method of claim 15, wherein closing the top flap of the container comprises inserting a top flap extension into the container after folding the plurality of top flaps, and adhering the top flap comprises gluing a first top flap to at least two remaining top flaps.

20. The method of claim 14, wherein adhering at least two of the plurality of bottom flaps comprises gluing each of first and second bottom flaps to each of third and fourth bottom flaps, or taping first and second opposed bottom flaps to first and second opposed sidewalls of the container.
